(19) United States
(12) Patent Application Publication
(10) Pub. No.: US 2020/0343064 A1
(43) Pub. Date: Oct. 29, 2020

(54) TEMPERATURE-DEPENDENT SWITCH AND METHOD OF MANUFACTURING A TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 16/855,475

(22) Filed: Apr. 22, 2020

(30) Foreign Application Priority Data
Apr. 23, 2019 (DE) 10 2019 110 448.3

(51) Int. Cl. H01H 37/54; H01H 37/04; H01H 1/50

(52) U.S. Cl. CPC H01H 37/5427; H01H 2037/046; H01H 1/50; H01H 37/04

(57) ABSTRACT

A temperature-dependent switch having a first electrode, a second electrode, a temperature-dependent switching mechanism, and a housing that accommodates the switching mechanism. The first electrode is connected to a stationary contact that is arranged inside the housing and the switching mechanism comprises a component that is movable relative to the housing, on which movable component a movable contact member is arranged. The switching mechanism is configured to switch, depending on its temperature, between a closed state of the switch and an open state of the switch. A first terminal member is attached to the first electrode by a first welded joint produced by ultrasonic welding and/or a second terminal member is attached to the second electrode by a second welded joint produced by ultrasonic welding and/or the stationary contact is attached to a part of the first electrode arranged inside the housing by a third welded joint produced by ultrasonic welding and/or the movable contact member is fastened to the movable component by a fourth welded joint produced by ultrasonic welding.

### CROSS REFERENCE TO RELATED APPLICATIONS

This application claims priority from German patent application DE 10 2019 110 448.3, filed on Apr. 23, 2019. The entire content of this priority application is incorporated herein by reference.

### BACKGROUND

This disclosure relates to a temperature-dependent switch. Furthermore, the disclosure relates to a method of manufacturing a temperature-dependent switch.

An exemplary temperature-dependent switch is disclosed in DE 10 2014 116 888 A1. Such temperature-dependent switches are typically used to protect electrical devices, such as hair dryers, lye pump motors, irons etc., from overheating and/or excessive current.

To this end, the temperature-dependent switch is connected electrically in series with the device to be protected in its supply circuit, so that the operating current of the device to be protected flows through the temperature-dependent switch. Furthermore, the switch is mounted on the device to be protected in such a way that it assumes the temperature of the device to be protected.

The temperature-dependent switch disclosed in DE 10 2014 116 888 A1 comprises a temperature-dependent switching mechanism which is arranged in a housing of the switch and which, depending on its temperature, opens or closes an electrical connection between two electrodes of the switch.

The term “electrode” is to be interpreted in its most general way in this respect. It is an electrical contact point which serves to connect the switch to the electrical device to be protected, or which is in electrically conductive connection with such an external terminal of the switch. The electrodes may therefore also be referred to as terminal electrodes. The electrodes may be inserted from outside into the inside of the housing, they may be attached to the housing of the switch, or they may be formed by parts of the housing itself.

In the case of the switch disclosed in the aforementioned DE 10 2014 116 888 A1, the housing includes an electrically conductive upper part and a lower part which is electrically insulated from the upper part, wherein the upper part forms the first electrode and the lower part forms the second electrode.

To enable the above-mentioned switching function, the switching mechanism of the switch, which is arranged inside the housing, usually comprises a bi-metal member which, when reaching its switching temperature, abruptly deforms from its low-temperature position to its high-temperature position, thereby lifting off a movable contact member, which is arranged at a component that is movable relative to the housing, from a stationary contact.

The stationary contact is connected to one of the two electrodes, while the movable contact member interacts either via the bi-metal member or a spring member assigned to the bi-metal member, which spring member may be configured, for example, as a spring snap disc, for example.

Designs are also known in which the movable component is configured as a contact bridge, which is supported by the bi-metal member and directly establishes an electrical connection between the two electrodes.

An example of such a temperature-dependent switch is disclosed in DE 197 08 436 A1. In this case not only the first electrode but also the second electrode is located on the upper part of the housing. The upper part of the housing is then made of insulating material or PTC-material. A stationary contact is arranged at each of the two electrodes. In the closed state of the switch, the current flows from the first electrode via the stationary contact assigned to the first electrode, through the contact bridge, to the other stationary contact, and from there to the second electrode, so that the operating current does not flow through the bi-metal member and the spring member itself.

This design is chosen in particular in case very high currents occur which can no longer be easily conducted via the spring member and/or the bi-metal member.

In the two design variants mentioned above, the bi-metal member is preferably configured as a bi-metal disc, which in the low-temperature position is preferably arranged in a force-free manner in the switching mechanism. The spring member, which is preferably configured as a spring snap disc, is mechanically coupled to the bi-metal member. The spring member is clamped in the housing, connected to it with a material bond or inserted into the housing.

In principle, however, it is also possible to dispense with the spring member completely, which is particularly the case in cheaper versions of such temperature-dependent switches. In such a case, the function of the spring member is taken over by the bi-metal member.

To connect the known temperature-dependent switches with the device to be protected, the switch is typically provided with supply lines or terminal members which are attached to the two electrodes. Usually, flexible stranded wires or rigid terminal lugs are connected to the electrodes by means of a material bond. The stranded wires or terminal lugs are often soldered or welded to the switches known from the state of the art. The pre-assembled switches provided with stranded wires or terminal lugs are then provided with a cap or shrink cap to electrically insulate the switches from the outside.

However, soldering or welding the supply lines or terminal members has proven to be problematic in many respects. Especially the common welding methods have a number of disadvantages. They pollute the environment, require special designs for the switch, and are time-consuming and costly. Furthermore, they lead to a strong heating of the switch, which can cause the welding to trigger a switching operation, which is generally undesirable and causes problems especially with one-time switches, which only produce a single irreversible switching operation.

Such an undesirably strong heat development at the switch components occurs especially with the hot welding or fusion welding processes that are usually used. Experiments by the applicant in which terminal lugs were soldered or welded to the cover part of the switch have shown, for example, that the heat development directly on the cover part causes the stationary contact located inside the housing to detach from the electrode or the cover part. Similarly, the heat development can also cause the stationary contact and the movable contact member to undesirably weld together or at least change their geometry in such a way that the pre-assembled switches no longer switch or at least no longer switch reliably. Furthermore, the heat penetrating into the interior of the housing during the welding process can cause the snap discs to be damaged, so that their required switching characteristics are inadmissibly altered. In thin-walled housings, perforation burning is often also a problem. In the worst case, all this can lead to a total failure of the switch.

The described heat development occurring inside the switch is particularly distinctive if the cover part and/or the lower part of the housing is made of metal and the supply lines or terminal members are welded or soldered directly to it. In this case a particularly strong heat development occurs inside the housing due to the very good heat conduction properties of the metal. This is all the more critical because the supply lines or terminal members are typically attached to the housing after the switching mechanism has already been mounted in the housing and this has been closed, i.e. after the switch itself is already provided as a finished or at least semi-finished component. It is then only possible to check to a limited extent, or at least only with great effort, whether the heat generated inside the switch has lead to any of the above-mentioned damage.

For the attachment of cable lugs, which are often used for the connection of the switch, welding methods are out of the question anyway, as multi-conductor stranded wires must not be welded. However, soldering these cable lugs also causes the above-mentioned strong heat development inside the switch, so that this is not an entirely satisfactory solution either.

On the other hand, a switch, such as the one disclosed in DE 20 2014 010 782 U1, for example, does not cause the above-mentioned problems associated with welding or soldering the supply lines or terminal members. In this case, the housing is made of plastic and the electrodes are led to the outside in the form of metal sheets or metal strips. Due to the low heat conduction properties of the housing and the fact that the welded or soldered connection is then made relatively far away from the inside of the housing and thus far away from the switching mechanism, neither the housing itself heats up nor are the components inside the housing exposed to a greater heat development.

Regardless of the design of the switch, welding or soldering of contact points to components inside the switch has also proven to be problematic. This is particularly true if these components are in indirect or even direct contact with the highly sensitive switching mechanism of the switch or if they form part of this switching mechanism. For example, the attachment of the movable contact member to the movable component of the switching mechanism by welding is particularly critical. As already mentioned above, the movable component of the switching mechanism typically comprises a spring snap disc and/or a bi-metal snap disc. Conventional spring snap discs and bi-metal snap discs have a very small thickness of, for example, 2 mm, 1 mm or less, so that optimal welded joints may only be achieved with great difficulty. If at all possible, this can also easily lead to damages of the spring snap disc and/or the bi-metal snap disc.

In addition to the above-mentioned environmental risks and cost risks, the joining processes typically used in the switch manufacture can result in an undesirably high reject rate.

### SUMMARY

It is an objective to provide a temperature-dependent switch and a method for manufacturing the same, which reduce or even completely avoid the disadvantages mentioned above. In particular, it is an objective to reduce the production-related rejects and yet guarantee a cost-effective production of the switch.

According to a first aspect, a temperature-dependent switch is provided, which comprises:
a temperature-dependent switching mechanism; and
a housing that accommodates the switching mechanism and comprises an upper part and a lower part that is electrically insulated from the upper part;

wherein at least a part of the upper part is made of electrically conductive material and forms a first electrode, wherein at least a part of the lower part is made of electrically conductive material and forms a second electrode,

wherein the first electrode is connected to a stationary contact that is arranged inside the housing, and wherein the switching mechanism comprises a component that is movable relative to the housing, on which movable component a movable contact member is arranged,

wherein the switching mechanism is configured to switch, depending on its temperature, between a closed state of the switch, in which the movable contact member interacts with the stationary contact and establishes an electrically conductive connection between the first electrode and the second electrode, and an open state of the switch, in which the movable contact member is kept at a distance from the stationary contact and the electrically conductive connection be-tween the first electrode and the second electrode is disconnected, and

wherein (i) a first terminal member is attached to the first electrode by a first welded joint produced by ultrasonic welding and/or (ii) a second terminal member is attached to the second electrode by a second welded joint produced by ultrasonic welding.

The inventor has recognized that the manufacture of the two mentioned welded joints by means of ultrasonic welding eliminates the above-mentioned disadvantages to a large extent or even completely. This is all the more surprising as the inventor had originally assumed a complete renunciation of welded joints at the positions mentioned above.

However, it has turned out that welding the supply lines or terminal members directly to the housing by means of ultrasonic welding is not only possible, but also offers various unforeseen advantages.

Due to the comparatively low heat development that is generated during ultrasonic welding, temperature-related damages inside the switch, especially to the sensitive switching mechanism, can be effectively prevented. This also applies when the housing of the switch is largely made of metal. Despite the very good heat conduction properties of the metal, the comparatively low heat development that occurs during ultrasonic welding does not cause the stationary contact, which is typically located on the upper part of the housing, to become undesirably detached. There is also no risk that the stationary contact and the movable contact member are welded together during the ultrasonic welding process. The risk of the snap discs being damaged by the ultrasonic welding process is also reduced to a minimum.

Welded joints produced by ultrasonic welding therefore prove to be particularly advantageous for switches where the entire upper and lower parts are made of electrically conductive material.

Welded joints produced by ultrasonic welding have also proven to be advantageous for one-time switches, as there is no risk of triggering an undesired switching operation due to the comparatively low heat development.

In addition, cold soldering joints (i.e. soldering joints where there is no material connection between the soldering and joining partners) can be avoided through the use of ultrasonic welding.

In addition, ultrasonic welding can be used to achieve clean and sustainable joints between the components mentioned above. In contrast to the typically used fusion welding processes, the surface finishing of the surfaces is not adversely affected by ultrasonic welding. This also leads to comparatively lower contact resistances at the mentioned joints.

A further advantage is that no filler materials are required for ultrasonic welding. This allows more compact welding seams to be produced. In addition, the environment is significantly less polluted, as the use of environmentally harmful materials, which are typically included in the filler materials, may be completely avoided.

In ultrasonic welding, the welding of the components to be joined is achieved by means of a high-frequency mechanical oscillation. The generated oscillation leads to heating between the components to be joined due to molecular friction and interfacial friction. If the components to be joined are metals, the mechanical oscillation generated by ultrasound causes the joining partners to indent and interlock at the joint.

In ultrasonic welding tools, a generator generates electronic oscillations which are converted into mechanical oscillations by an ultrasonic converter. These are fed to the components to be joined via a so-called sonotrode. Within fractions of a second, the ultrasonic oscillations generated in this way generate frictional heat on the joining surfaces of the components to be joined, which causes the material to melt and to join the components together.

The parameters to be set during ultrasonic welding, such as amplitude and frequency, can be adapted to the conditions. The parameters to be set and their respective values are known to the skilled person and can be taken from the relevant standards.

In a refinement, the first terminal member and/or the second terminal member comprises a terminal lug or stranded wire. These are preferably attached directly to the housing by ultrasonic welding.

For example, when terminal lugs are used, a first terminal lug may be attached by ultrasonic welding to a first shoulder provided at the upper part and a second terminal lug may be attached by ultrasonic welding to a second shoulder provided at the lower part. Due to the small thickness of such terminal lugs as well as due to their attachment to the aforementioned shoulders of the housing, the overall height of the switch is comparatively low.

In a further refinement, the shoulders are each configured as an annular shoulder and the respective first end of the terminal lugs is ring-shaped.

This further facilitates the manufacture, as no positioning work is required between the terminal lug and the housing part. Instead, the housing part is inserted with its underside into the annular end in such a way that it rests on the shoulder, i.e. automatically centers itself.

In a further refinement, the first terminal lug or stranded wire is attached at its first end to the first electrode by means of the first welded joint, and its second end that is remote from the first end serves as the first connection. Similarly, the second terminal lug or stranded wire may by at its first end to the second electrode by the second welded joint, and its second end that is remote from the first end may serve as the second terminal.

According to a second aspect, there is provided a temperature-dependent switch comprising:
a first electrode;
a second electrode;
a temperature-dependent switching mechanism; and
a housing accommodating the switching mechanism;

wherein the first electrode is connected to a stationary contact that is arranged inside the housing, and wherein the switching mechanism comprises a component that is movable relative to the housing, on which movable component a movable contact member is arranged,

wherein the switching mechanism is configured to switch, depending on its temperature, between a closed state of the switch, in which the movable contact member interacts with the stationary contact and establishes an electrically conductive connection between the first electrode and the second electrode, and an open state of the switch, in which the movable contact member is kept at a distance from the stationary contact and the electrically conductive connection between the first electrode and the second electrode is disconnected, and

wherein (i) the stationary contact is attached to a part of the first electrode by a third welded joint produced by ultrasonic welding, said part of the first electrode being arranged inside the housing and/or (ii) the movable contact member is attached to the movable component by a fourth welded joint produced by ultrasonic welding.

The inventor has recognized that the disadvantages mentioned at the beginning can also be largely or even completely eliminated by producing these two welded joints by means of ultrasonic welding.

Welding of the stationary contact with the part of the first electrode arranged in the inside and/or welding of the movable contact member with the movable component of the switching mechanism by means of ultrasonic welding also leads to the aforementioned advantages of ultrasonic welding at these positions of the switch.

In a refinement, the temperature-dependent switching mechanism of the switch includes a bi-metal member.

A bi-metal member may be a multilayer, active, sheet metal shaped component comprising two, three or four inseparably connected components with different coefficients of thermal expansion. The connection of the individual layers of metals or metal alloys is by means of a material bond or positive locking and is achieved, for example, by rolling.

Such bi-metal members have a first stable geometrical conformation in their low-temperature position and a second stable geometrical conformation in their high-temperature position, between which they switch in a temperature-dependent manner in the manner of a hysteresis. If the temperature changes beyond their response temperature or below their reset temperature, the bi-metal members snap over into the other conformation, respectively. The bi-metal members are therefore often referred to as snap discs, wherein they can have an elongated, oval or circular shape when viewed from above.

If the temperature of the bi-metal member rises above the transition temperature as a result of an increase in the temperature of the device to be protected, the bi-metal member changes its configuration so that the movable contact member is kept at a distance from the stationary contact, thereby opening the switch and switching off the device to be protected and preventing further heating.

Below its transition temperature, i.e. in its low-temperature position, the bi-metal member is preferably mounted in the housing of the switch in a mechanically force-free manner. The bi-metal member is preferably not to used for conducting the current.

It is advantageous that such bi-metal members have a long mechanical service life and that the switching point, i.e. the transition temperature of the bi-metal member, does not change even after many switching cycles.

According to another refinement, the bi-metal member is the movable component on which the movable contact member is arranged.

This refinement is particularly suitable if low demands are made on the mechanical reliability or the stability of the transition temperature. The bi-metal member may then also take over the function of the spring member or of the spring snap disc and possibly even of the current transfer element, so that the switching mechanism includes only one bi-metal member, which then carries the movable contact member. The bi-metal member then not only provides the closing pressure of the switch, but also carries the current in the closed state of the switch. In the closed state of the switch, the bi-metal member is thus electrically connected in series between the first and the second electrode, which form the external terminals of the switch, or at which the external terminals of the switch are arranged.

The welded joint produced by means of ultrasonic welding (here called fourth welded joint) is in this refinement thus provided between the bi-metal member, which forms the movable component of the switching mechanism, and the movable contact member. Due to the usually very thin-walled bi-metal members, this type of welded joint between the bi-metal member and the movable contact member is particularly advantageous, since the risk of damage and/or the risk of the bi-metal member snapping over unintentionally is considerably reduced due to the comparatively low heat development during the ultrasonic welding process. This has a beneficial effect on the functioning of the bi-metal member and also extends its service life.

In a further refinement, the temperature-dependent switching mechanism includes a bi-metal member and a spring member that interacts with the bi-metal member.

The bi-metal member is preferably a temperature-dependent bimetal snap disc. The spring member is preferably a bistable spring snap disc.

The spring snap disc operates against the bimetal snap disc and generates the closing pressure of the switch. If the switch cools down again after a switching operation which has brought the switch to its open state, the spring snap disc operating against the bi-metal snap disc ensures that the bi-metal snap disc is reset to bring the switch back to its closed state.

If the switching mechanism includes such a spring member in addition to the bi-metal member, it is preferred that the spring member is the movable component on which the movable contact member is arranged.

The movable contact member is, in this refinement, thus attached to the spring member by the fourth welded joint produced by ultrasonic welding. Depending on the design of the switch, the spring member can, in the closed state of the switch, then be electrically connected in series between the first and the second terminal electrode. In the closed state of the switch, the spring member then carries the current flowing through the switch.

According to a further refinement, the bi-metal member is held captive with clearance on the movable contact member, wherein the movable contact member is attached to the spring member, which is achieved by the fourth welded joint produced by ultrasonic welding.

Since the spring member, the bi-metal member and the movable contact member then form a single unit, the switching mechanism can be stored temporarily as a separate semi-finished part before it is mounted in the housing of the switch. A separate test of the switching mechanism is thus also possible, as the bi-metal member is held captive but has a clearance so that it can deform in an unhindered manner between its low-temperature position and its high-temperature position.

The use of ultrasonic welding to connect the spring member to the movable contact member is particularly advantageous for a switch according to the aforementioned refinement. Since the movable contact member is attached to the spring member by means of ultrasonic welding and the bi-metal member is held captive but with clearance on the movable contact member, the bi-metal member is hardly subjected to any thermal stress during the ultrasonic welding process. It is particularly preferred that the welding process between the spring member and the movable contact member occurs before the bi-metal member is attached to the movable contact member. In this case, the bi-metal member is not stressed at all by the welding process.

Preferably, the housing comprises an upper part and a lower part that is electrically insulated from the upper part, wherein the upper part forms the first electrode and the lower part forms the second electrode, and wherein the stationary contact is arranged on an inner side of the upper part facing the interior of the housing.

In this refinement, the upper part and the lower part of the housing are preferably made of an electrically conductive material, for example metal. As contact terminals for the external connections of the switch, an outer side of the upper part facing away from the inside of the housing can be used on the one hand and an outer side of the lower part facing away from the inside of the housing can be used on the other hand. Hence, the upper part and the lower part themselves form the terminal electrodes.

The lower part of the housing can, for example, be pot-shaped and accommodate the temperature-dependent switching mechanism. After insertion of the temperature-dependent switching mechanism, the lower part of the housing is closed, for example by the upper part of the housing, which can be configured as a kind of cover, with an insulating foil inserted between. For this purpose, a surrounding edge of the lower part of the housing can be flanged to secure the cover part.

Before the housing is closed, the stationary contact is attached by means of ultrasonic welding (presently referred to as the third welded joint) to the inner side of the upper part, which inner side faces the inside of the housing.

In an alternative refinement, the housing comprises an upper part made of insulating material or PTC-material and a lower part, wherein the first and the second electrode are arranged at the upper part.

The lower part can also be made of insulating material or PTC material in this refinement. However, it can also be made of metal, which is preferred, as this improves the thermal coupling of the switch to the device to be protected. In this case, however, the raised metallic edge of the lower part often has to be electrically insulated from the outside.

The movable component of the switching mechanism is in the last-mentioned configuration preferably a contact element coupled to a bi-metal member, on which contact element a second movable contact member is arranged in addition to the (first) movable contact member, wherein a second stationary contact is attached to a part of the second electrode arranged inside the housing by a fifth welded joint produced by means of ultrasonic welding.

In this case, there are thus two stationary contacts, each of which is attached to one of the two electrodes arranged at the upper part of the switch by a welded joint produced by ultrasonic welding. The movable component of the switching mechanism is assigned to the two stationary contacts, wherein the movable component is in this refinement preferably designed as a current transfer element in the form of a movable contact bridge which is mechanically connected to the bi-metal member. Corresponding to the two stationary contacts, two contact surfaces are provided on this contact bridge, wherein the two contact surfaces are herein designated as first and second movable contact member, respectively.

In the closed state of the switch, the current flows according to this refinement from the first electrode, via the first stationary contact and the first movable contact member contacting the first stationary contact, through the contact element acting as a contact bridge, via the second movable contact member and the second stationary contact, to the second electrode. Neither the bi-metal member nor the spring member of the switching mechanism carries current according to this refinement.

In a further refinement, at least a part of the housing is made of insulating material or PTC-material, wherein (i) a first portion of the first electrode extends into the interior of the housing and a second portion of the first electrode extends outward from the interior of the housing and/or (ii) a first portion of the second electrode extends into the interior of the housing and a second portion of the second electrode extends outward from the interior of the housing.

The housing may be constructed in one or more parts according to this refinement. It may be completely or only partially made of insulating material or PTC-material. Each of the two electrodes are preferably inserted from outside as contact plates or connection plates into the interior of the housing through one opening, respectively. The electrodes may abut the inner wall of the housing or they may be at least partially freely suspended in it. For example, this may correspond to arrangements of the switching mechanism as disclosed in DE 196 09 310 A1 or EP 2 511 930 A1.

According to a third aspect, a method of manufacturing a temperature-dependent switch is presented, comprising:
a) providing a switching mechanism and a housing having an upper part and a lower part, wherein at least a part of the upper part is made of electrically conductive material and forms a first electrode and at least a part of the lower part is made of electrically conductive material and forms a second electrode,
b) mounting the switching mechanism in the housing such that the first electrode is connected to a stationary contact that is arranged inside the housing and the switching mechanism comprises a component that is movable relative to the housing, on which movable component a movable contact member is arranged, and such that the switching mechanism switches, depending on its temperature, between a closed state of the switch, in which the movable contact member interacts with the stationary contact and establishes an electrically conductive connection between the first and the second electrode, and an open state of the switch, in which the movable contact member is kept at a distance from the stationary contact and an electrically conductive connection between the first and the second electrode is open,
c) closing the housing by attaching the upper part to the lower part, wherein the upper part is electrically insulated from the lower part;
d1) attaching of a first terminal member to the first electrode by a first welded joint produced by ultrasonic welding, and/or
d2) attaching a second terminal member to the second electrode by a second welded joint produced by ultrasonic welding.

It should be noted that the above-mentioned features and the features contained in the claims defined in relation to the switch may also be applied mutatis mutandis in the method.

In a refinement, it is preferred that step d1) and/or step d2) is carried out after step c).

The first and/or second terminal member is therefore preferably welded to the housing after the switching mechanism has already been inserted into the housing and the housing has been closed. Hence, already before welding the terminals, the switch is available as a finished component. By using ultrasonic welding for the subsequent attachment of the switch terminals, undesirable damages inside the switch can be effectively avoided, as mentioned above.

According to fourth aspect, a method of manufacturing a temperature-dependent switch is presented, comprising:
a) providing a first electrode, a second electrode, a temperature dependent switching mechanism and a housing,
b) mounting the switching mechanism in the housing, such that the first electrode is connected to a stationary contact that is arranged inside the housing and the switching mechanism comprises a component that is movable relative to the housing, on which movable component a movable contact member is arranged, and such that the switching mechanism switches, depending on its temperature, between a closed state of the switch, in which the movable contact member interacts with the stationary contact and establishes an electrically conductive connection between the first and the second electrode, and an open state of the switch, in which the movable contact member is kept at a distance from the stationary contact and the electrically conductive connection between the first and the second electrode is open, and
c1) attaching the stationary contact to a part of the first electrode by a third welded joint produced by ultrasonic welding, said part of the first electrode being arranged inside the housing, and/or
c2) attaching the movable contact member to the movable component by a fourth welded joint produced by ultrasonic welding.

According to a refinement of the method, the stationary contact is attached to the part of the first electrode arranged inside the housing by the third welded joint produced by ultrasonic welding and/or the movable contact member is attached to the movable component by the fourth welded joint produced by ultrasonic welding, before the switching mechanism is mounted in the housing in step ii).

The ultrasonic welded joints produced on the switching mechanism therefore have no effect on the remaining components of the switch, for example on its external contacts, which can be arranged subsequently on the finished assembled housing.

According to a further refinement, a bi-metal member and a spring member interacting with the bi-metal member are provided as parts of the switching mechanism in step a), wherein the spring member forms the movable component on which the movable contact member is arranged, and wherein the movable contact member is attached to the spring member by the fourth welded joint produced by ultrasonic welding, and thereafter the bi-metal member is captively attached with clearance to the movable contact member before the switching mechanism is mounted in the housing in step b).

This results in the above-mentioned advantage that the ultrasonic welded joint between the spring member and the movable contact member has no influence on the bi-metal member, as this is fitted to the switching mechanism thereafter. The switching mechanism can also be pre-assembled as a semi-finished component, which is then mounted in the housing as a whole.

Further features and advantages emerge from the attached drawings and their subsequent description.

It is to be understood that the features mentioned above and the features yet to be explained below are usable not only in the combination provided in each case but also in other combinations or standing alone without departing from the spirit and scope of the present disclosure.

### BRIEF DESCRIPTION OF THE DRAWINGS

FIG. 1 shows a schematic cross-section of a temperature-dependent switch according to a first embodiment;

FIG. 2 shows a schematic cross-section of a temperature-dependent switch according to a second embodiment;

FIG. 3 shows a schematic cross-section of a temperature-dependent switch according to a third embodiment; and

FIG. 4 shows a schematic cross-section of a temperature-dependent switch according to a fourth embodiment.

### DESCRIPTION OF PREFERRED EMBODIMENTS

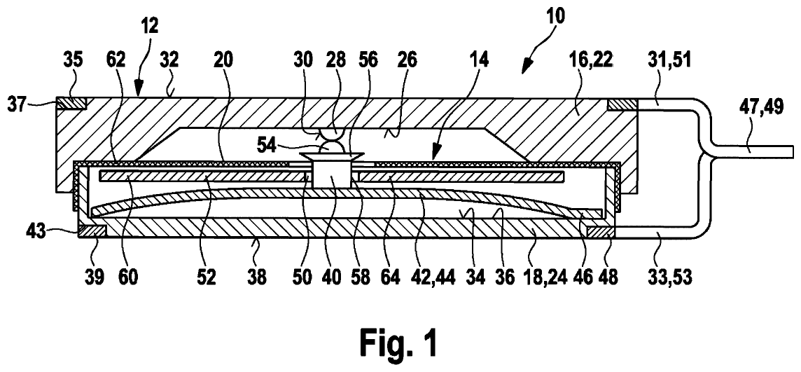

FIG. 1 shows a first embodiment of the temperature-dependent switch in a schematic cross-sectional view. The switch is denoted in its entirety with the reference numeral 10.

The switch 10 comprises a housing 12 and a temperature-dependent switching mechanism 14 accommodated therein. The housing 12 includes an upper part 16 made of electrically conductive material and a lower part 18 made of electrically conductive material.

Between the upper part 16 and the lower part 18 there is an insulating foil 20, which electrically isolates the upper part 16 from the lower part 18.

In this embodiment, the upper part 16 and the lower part 18 form the two electrodes 22, 24 of the switch 10. The two electrodes 22, 24 serve as contact points at which external terminals can be arranged to connect the switch 10 to a device to be protected. However, depending on the application, the two electrodes 22, 24 of the switch 10 can also be connected directly to the device to be protected.

For better differentiation, the electrode 22 formed by the upper part 16 is referred to below as “first electrode” and the electrode 24 formed by the lower part 18 is referred to as “second electrode”.

A stationary contact 28 is attached to an inner side 26 of the upper part 16 facing the inside of the housing 12, which comprises a contact surface 30 facing the lower part 18.

The stationary contact 28 is preferably attached to the inner side 26 of the upper part 16 by a welded joint produced by ultrasonic welding, wherein the inner side 26 forms the first electrode 22. The stationary contact 28 is thus electrically connected to the upper part 16, so that an upper side 32 of the upper part 16 facing away from the inside of the housing is available as the first external terminal of the switch.

The lower part 18, which functions as a second electrode 24, comprises a second contact surface 36 on its inside 34. Since the lower part 18 is also electrically conductive, its outer or lower side 38 serves as the second external terminal of switch 10.

Contact to the first electrode 22 is made via a first terminal member 31, which is attached to the upper part 16 by a welded joint produced by ultrasonic welding. The first terminal member 31 is configured as a terminal lug 51 in the embodiment shown in FIG. 1, wherein the terminal lug 51 is of annular shape at one end 35. With this annular end 35, the terminal lug 51 is supported on an outer, circumferential shoulder 37 of the upper part 16, which is set back in relation to the upper side 32. The extent of the recess of the shoulder 37 and the thickness of the terminal lug 51 are such that the terminal lug 51 does not project upwards beyond the upper part 16 in the region of its annular first end 35. In this way a low overall height is made possible.

In a similar way, in the embodiment shown in FIG. 1, contact to the second electrode 24 is made by a second terminal member 33, which is also configured as a terminal lug 53, which is attached to the lower part 18 by a welded joint produced by means of ultrasonic welding. The terminal lug 53 is of annular shape at its first end 39. With this annular end 39, the terminal lug 53 is supported on an outer circumferential shoulder 43 of the lower part 18, which is set back in relation to the underside 38. The extent of the recess of the shoulder 43 and the thickness of the terminal lug 53 are also selected so that the terminal lug 53 does not project downwards beyond the lower part 18 in the region of its annular first end 39. In addition to the resulting low overall height of the switch 10, this has the advantage that the lower part 18 can, if desired, be supported directly on the device to be monitored, which ensures good heat transfer.

Furthermore, FIG. 1 shows that the two terminal lugs 51, 53 are angled in such a way that their two second ends 47, 49, which are remote from the first ends 35, 39, are set back from the shoulders 37, 43 of housing 12. These second ends 47, 49 of the terminal lugs 51, 53 serve as terminals of the switch 10. For example, a stranded wire not visible in FIG. 1 may be attached to each of the two second ends 47, 49 of the terminal lugs 51, 53.

Depending on its temperature, the switching mechanism 14 located in the housing 12 establishes an electrically conductive connection between the upper part 16 and the lower part 18 and disconnects this electrically conductive connection abruptly when a response temperature or transition temperature is exceeded.

The switching mechanism 14 comprises a movable contact member 40 which is attached to a component 42 which is movable relative to the housing 12. In this embodiment, the movable component 42 of the switching mechanism 14 is a spring member 44 which is integrally connected to a lateral connecting bar which is attached at a point marked 48 to the second contact surface 36 provided on the lower part 18.

The spring member 44 is configured as a slightly domed spring snap disc, which centrally supports the movable contact member 40. The movable contact member 40 is attached to the spring snap disc 44 by a welded joint produced by ultrasonic welding. The lateral connection between the spring snap disc 44 and the contact surface 36 arranged on the lower part 18 is preferably also produced by ultrasonic welding.

A bi-metal member 52 with a central opening 50 sits on the movable contact member 40 with clearance but captive. In the state shown in FIG. 1, the bi-metal member 52 is in its low-temperature position in which it rests in a force-free manner on the spring snap disc 44. The bi-metal member 52 is designed as a bi-metal snap disc.

The movable contact member 40 has a dome-shaped tip 54, which, is, in the closed state of the switch 10 shown in FIG. 1, in contact with the stationary contact 28 or its contact surface 30. Below the dome-shaped tip 54, a flange 56 is provided on the movable contact member 40, to the lower end of which a cylindrical extension 58 is attached. As can be seen from FIG. 1, the flange 56 of the movable contact member 40 has a larger diameter than the central opening 50 provided in the bi-metal snap disc 52. The cylindrical projection 58, which extends through the central opening 50 of the bi-metal snap disc 52, has a smaller diameter than the central opening 50. This ensures that the bi-metal snap disc 52 is held captive but with clearance on the movable contact member 40.

When manufacturing the switching mechanism 14, the movable contact member 40 is first welded onto the spring snap disc 44 with the underside of the cylindrical extension 58. This welded joint is made by means of ultrasonic welding. Since ultrasonic welding generates considerably less heat between the two components to be joined than the fusion welding methods conventionally used, the spring snap disc 44 is hardly stressed. This is particularly advantageous because the spring snap disc 44 is usually a very thin-walled component with a thickness of only a few millimeters or even less. In addition, ultrasonic welding does not require any filler materials that are harmful to the environment. Nevertheless, the welded joint produced by ultrasonic welding creates a mechanically extremely stable and electrically highly conductive connection between the movable contact member 40 and the spring snap disc 44.

After producing the welded joint between the movable contact member 40 and the spring snap disc 44, the bi-metal snap disc 52 is placed from above with its central opening over the movable contact member 40. During this process, the flange 56 still has a smaller diameter than the central opening 50, as it is not yet spread or expanded laterally as shown in FIG. 1. The flange 56 of the movable contact member 40 is only expanded or widened after the bi-metal snap disc 52 has been inserted or turned over, which can be done by pressing, for example. The bi-metal snap disc 52 is then held captive, but with clearance, on the movable contact member 40, which in turn is connected to the spring snap disc 44.

The switching mechanism 14 manufactured in this way can then be inserted into the housing 12 as an already assembled semi-finished component and, as already mentioned, attached in the housing 12 by welding the spring snap disc 44 to the lower part 18. Since the welded joint between the movable contact member and the spring member 44 is produced by ultrasonic welding before the bi-metal snap disc 52 is placed over the contact member 40, the bi-metal snap disc 52 is not affected in any way by the welding process mentioned above. The welding process between the spring snap disc 44 and the lower part 18 also has no influence on the bi-metal snap disc 52, as the latter is held with clearance on the movable contact member 40 and therefore no direct heat transfer by heat conduction to the bi-metal snap disc 52 takes place. This has a positive effect on the functioning and service life of the bi-metal snap disc 52.

Due to the permanent mechanical and galvanic connection between the spring snap disc 44 and the lower part 18, there is a very low contact resistance between the lower part 18, acting as second electrode 24, and the spring snap disc 44.

Since the movable contact member 40 is welded to the spring snap disc 44 in the above mentioned manner, the contact resistance between the spring snap disc 44 and the movable contact member 40 is also extremely low.

By selecting a suitable surface finish of the dome-shaped tip 54 of the contact member 40 and the first contact surface 30 of the stationary contact 28, the contact resistance is also very low there.

The ultrasonic welded joint produced between the stationary contact 28 and the upper part 16 also results in a very low contact resistance between these two components.

The upper part 16 and the lower part 18 can therefore be designed as inexpensive deep-drawn parts, because the quality of the contact resistances is provided by the described welded joints.

In this way, the entire switch 10 has only a very low contact resistance between the first electrode 22 and the second electrode 24, so that it is virtually a galvanic short circuit.

If, starting from the closed state of the switch 10 shown in FIG. 1, its temperature now increases above the transition temperature of the bi-metal snap disc 52, the latter moves downwards in FIG. 1 with its still free edge 60 in FIG. 1 until this edge 60 comes into contact with the insulating foil 20 where it is located below an annular rim 62 of the upper part 16.

In doing so, the bi-metal snap disc 52 presses with its central area 64 centrally on the spring snap disc 44 and pushes it downwards as shown in FIG. 1, lifting the movable contact member 40 from the stationary contact 28, so that the switch 10 opens.

When the ambient temperature and thus the temperature of the bi-metal snap disc 52 cools down again below the transition temperature, the bi-metal snap disc 52 returns to its low-temperature position shown in FIG. 1, causing the opening pressure on the spring snap disc 44 to decrease. Due to the internal forces, the spring snap disc 44 then resets to its rest position shown in FIG. 1, in which it is clamped between the inside 34 of the lower part 18 and the stationary contact 28, thus ensuring an attached contact pressure and a securely closed switch 10.

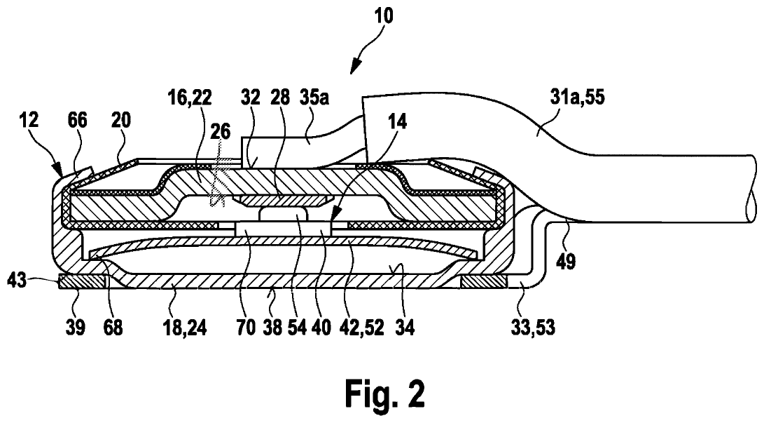

FIG. 2 shows a second embodiment of a temperature-dependent switch, which in its entirety is also denoted with the reference numeral 10. Components which correspond to the components of the switch according to the first embodiment shown in FIG. 1 are marked with the same reference number in FIG. 2. For the sake of simplicity, only the essential differences to the first embodiment shown in FIG. 1 are described below.

The housing 12 of the switch 10 shown in FIG. 2 includes an electrically conductive, pot-like lower part 18, which is closed by an electrically conductive upper part 16, which is configured here as a cover part. The upper part 16 is held on the lower part 18 by a flanged edge 66 with an interposed insulating foil 20.

The upper part 16 and the lower part 18 also in this case form the two electrodes 22, 24 of switch 10, and accordingly the upper side 32 of the upper part 16 serves as the first connection surface, and the outer side 38 of the lower part 18 serves as the second connection surface. Supply lines can be attached to these two connection surfaces by means of stranded wires or terminal lugs in order to connect switch 10 to a device to be protected.

Similar to the first embodiment, the second terminal member 33 is configured as a terminal lug 53, the annular first end 39 of which is attached to the shoulder 43 surrounding the lower part 18 by a welded joint produced by ultrasonic welding. The first terminal member 31a is configured here, however, as a stranded wire 55, which is attached with its stripped first end 35a to the upper side 32 of the upper part 16 by a welded joint produced by means of ultrasonic welding. It goes without saying that in principle the second terminal member 33 may also be configured as a stranded wire, which is attached to the underside 38 of the lower part 18 by a welded joint produced by means of ultrasonic welding. In the same way it is also possible with the switch design shown in FIG. 2 to use a terminal lug 51 as shown in FIG. 1 for the first terminal member 31a.

The stationary contact 28 is, similar to the first embodiment, preferably attached to the inner or lower side 26 of the upper part 16 by a welded joint produced by ultrasonic welding.

In contrast to the first embodiment shown in FIG. 1, the switch 10 shown in FIG. 2 does not comprise a spring snap disc 44. Instead, the bi-metal snap disc 52 functions as movable component 42, to which the movable contact member 40 is attached. The bi-metal snap disc 52 takes over the function of the spring snap disc 44 in the example of switch 10 shown in FIG. 2.

The bi-metal snap disc 52 is clamped in the housing 12 in such a way that in its low-temperature position, as shown in FIG. 2, it rests on and contacts the inner side 34 of the lower part 18. In principle, however, the bi-metal member 52 may also be designed as a bi-metal spring clamped on one side, which is connected at a contact member to the inside 34 of the lower part 18 by means of a material bond.

Additionally, it is to be understood that with the same construction of the housing 12, the switching mechanism 14 may also have a spring snap disc 44 according to this embodiment, so that a similar construction of the switching mechanism 14 as shown in FIG. 1 then results.

In the embodiment shown in FIG. 2, the movable contact member 40 also has a dome-shaped tip 54, at the lower end of which there is in this case a widened socket 70, the underside of which is attached to the bi-metal snap disc 52. This attachment is realized by a welded joint produced by ultrasonic welding. In addition to the above-mentioned advantages of ultrasonic welding, another advantage is that a welded joint produced by ultrasonic welding at this point protects the very sensitive and typically thin-walled bi-metal snap disc 52. A hot welding process used at this point to connect the movable contact member 40 with the bi-metal snap disc 52 could damage the bi-metal snap disc 52 to such an extent that its function is permanently impaired.

With regard to the embodiment shown in FIG. 2, it should also be mentioned that the upper part 16 does not necessarily have to be made of electrically conductive material. It can also be made of insulating material or Positive Temperature Coefficient (PTC) ceramics. In such a case, the first connection surface of the switch 10 is formed by a metal layer arranged on the upper side 32, which metal layer is plated through the upper part 16 to the stationary contact 28. Therefore, in this case only a part of the upper part 16 would be made of electrically conductive material (metal layer). This metal layer then forms the first electrode 22 of switch 10, so that a corresponding lead can be attached to it, for example by means of a stranded wire or a terminal lug. According to the terminology used herein, the first electrode 22 of switch 10 would then not be formed by the entire upper part 16, but only by a part of it or would be located on it.

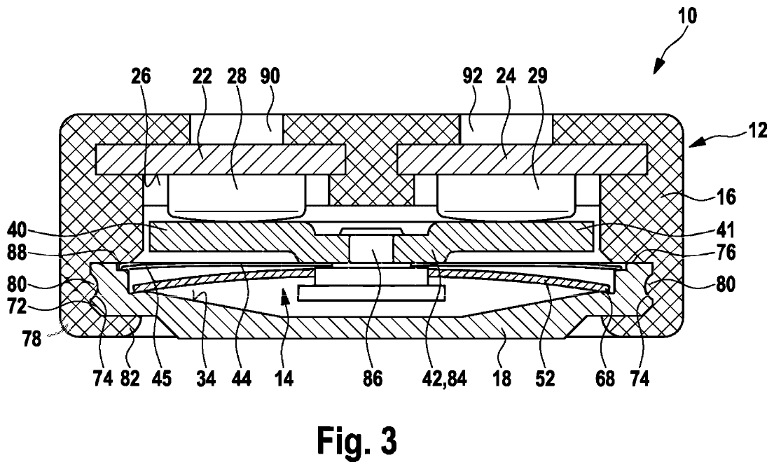

FIG. 3 shows a third embodiment of the temperature-dependent switch 10. Components which correspond to the components shown in FIGS. 1 and 2 are for the sake of simplicity again denoted here with the same reference numerals as before.

An essential difference to the two embodiments shown above is that both terminal electrodes 22, 24 of the switch 10 are arranged at the upper part 16. Accordingly, the construction of the housing 12 as well as the construction of the switching mechanism 14 differs in some features, which will be explained in the following in detail.

The housing 12 comprises a plate-like lower part 18, on the raised edge 72 of which an external circumferential groove 74 is provided. The upper part 16, which is in this case essentially cup-shaped, is supported on the raised edge 72 by an inner shoulder 76. An edge 78 projects over the shoulder 76, on which an inner circumferential bead 80 is provided, which engages with the groove 74, whereby the lower part 18 is locked with the upper part 16. The edge 78 merges into a ring-shaped overlap 82, by means of which the lower part 18 is held further on the upper part 16.

This overlap 82 can be created by embossing or welding a projecting area of the edge 78.

While the upper part 16 is made of insulating material, the lower part 18 can also be made of insulating material or of metal, wherein a lower part 18 made of metal provides a better thermal connection of the switch 10 to a device to be protected.

The two electrodes 22, 24, which are located next to each other, are cast into the upper part 16, each of which carries a stationary contact 28, 29. In contrast to the two embodiments mentioned above, the switch, according to the embodiment shown in FIG. 3, therefore, comprises not only one stationary contact 28 but also a second stationary contact 29. The two stationary contacts 28, 29 are each attached to the first and second electrode 22, 24, respectively, by a welded joint produced by ultrasonic welding. This welded joint produced by ultrasonic welding provides similar advantages as described above with regard to the connection of the stationary contact 28 with the upper part 16 forming the first electrode 22.

A movable contact member 84 in the form of a movable contact bridge is assigned to the two stationary contacts 28, 29. In this example, this movable contact member 84 functions as movable component 42 of the switching mechanism 14, on which a first and a second contact member 40, 41 are arranged. The two movable contact members 40, 41 are preferably integrally connected to each other.

The movable contact member 84, configured as a contact bridge, is mechanically coupled with the spring snap disc 44 and the bi-metal snap disc 52 via a rivet 86. The bi-metal snap disc 52 is supported with its edge 68 in the closed state of the switch 10 shown in FIG. 3 on the inside 34 of the lower part 18. The edge 45 of the spring snap disc 44 is circumferentially guided in a circumferential groove 88, which is formed between the shoulder 76 of the upper part 16 and the edge 72 of the lower part 18.

Depending on the temperature, the switching mechanism 14 brings the contact member 84 coupled with the bi-metal snap disc 52 into contact with the two stationary contacts 28, 29 or lifts the contact member 84 from the two stationary contacts 28, 29.

Additionally, the two openings 90, 92 in FIG. 3 should be mentioned, which are located on the upper sides of electrodes 22, 24 facing away from the stationary contacts 28, 29. These openings 90, 92, which lead outwards, serve on the one hand for a thermal coupling of the switch 10 to a device to be protected and on the other hand may be provided for test purposes, namely to heat up the inside of the switch 10 as quickly as possible by means of heating stamps and/or to contact the two stationary contacts 28, 29 from the outside by means of test pins in order to test the function of the switch 10.

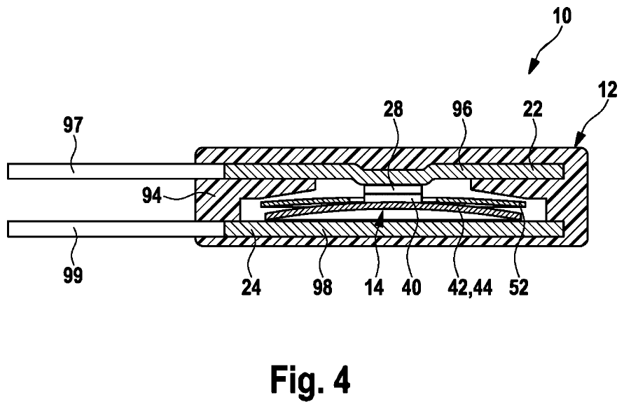

FIG. 4 shows a fourth embodiment in a schematic cross-sectional view. The basic construction of the switch shown therein is similar to switch 10 shown in FIG. 1.

Here, too, the switching mechanism 14 comprises a bi-metal snap disc 52 and a spring snap disc 44 coupled to it. The spring snap disc 44 again forms the movable component 42, to which the movable contact member 40 is attached.

The housing 12 consists of one or more parts and is at least partially made of insulating material or PTC-material. Although this is not explicitly shown in FIG. 4, the housing 12 may comprise one or more openings which improve the thermal connection of switch 10 to the device to be protected.

In contrast to the embodiments shown above, the two electrodes 22, 24 are here designed as connection plates which are passed through a side wall 94 of housing 12. A first part 96 of the first electrode 22 protrudes into the interior of the housing 12 and a second part 97 of the first electrode 22 is led through the side wall 94 from the interior of the housing 12 to the outside. Likewise, a first part 98 of the second electrode 24 projects into the interior of the housing 12 and a second part 99 of the second electrode 24 is led out of the interior of the housing 12. Preferably, the first two parts 96, 98 of the electrodes 22, 24 rest against an inner side of the housing 12 or are clamped in the housing 12. In principle, however, it would also be possible for these two parts 96, 98 of the electrodes 22, 24 to be arranged freely suspended inside the housing 12 and to be clamped on one side only at the point where they pass through the housing wall 94.

The stationary contact 28 is attached to the first part 96 of the first electrode 22 by means of a welded joint produced by ultrasonic welding. The movable contact member 40 is attached to the spring snap disc 44 by means of a welded joint produced by ultrasonic welding. In the low temperature position of switch 10 shown in FIG. 4, the bottom or outer edge of the spring snap disc 44 rests on the first part 98 of the second electrode 24, so that an electrical connection is established.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A temperature-dependent switch, comprising:
a temperature-dependent switching mechanism; and
a housing that accommodates the switching mechanism and comprises an upper part and a lower part that is electrically insulated from the upper part;
wherein at least a part of the upper part is made of electrically conductive material and forms a first electrode, wherein at least a part of the lower part is made of electrically conductive material and forms a second electrode,
wherein the first electrode is connected to a stationary contact that is arranged inside the housing, and wherein the switching mechanism comprises a component that is movable relative to the housing, on which movable component a movable contact member is arranged,
wherein the switching mechanism is configured to switch, depending on its temperature, between a closed state of the switch, in which the movable contact member interacts with the stationary contact and establishes an electrically conductive connection between the first electrode and the second electrode, and an open state of the switch, in which the movable contact member is kept at a distance from the stationary contact and the electrically conductive connection between the first electrode and the second electrode is disconnected, and
wherein (i) a first terminal member is attached to the first electrode by a first welded joint produced by ultrasonic welding and/or (ii) a second terminal member is attached to the second electrode by a second welded joint produced by ultrasonic welding.

2. The temperature-dependent switch according to claim 1, (i) wherein the first terminal member comprises a first terminal lug or stranded wire, and/or (ii) wherein the second terminal member comprises a second terminal lug or stranded wire.

3. The temperature-dependent switch according to claim 2, (i) wherein the first terminal lug or stranded wire is attached at its first end to the first electrode by the first welded joint and its second end that is remote from the first end serves as a first terminal; and/or (ii) wherein the second terminal lug or stranded wire is attached at its first end to the second electrode by the second welded joint and its second end that is remote from the first end serves as a second terminal.

4. The temperature-dependent switch according to claim 1, wherein each of the upper part and the lower part is made of electrically conductive material, and wherein an insulating element is arranged between the upper part and the lower part, wherein the insulating element is configured to electrically insulate the upper part from the lower part.

5. The temperature-dependent switch according to claim 1, wherein the stationary contact is attached to a part of the first electrode by a third welded joint produced by ultrasonic welding, said part of the first electrode being arranged inside the housing.

6. The temperature-dependent switch according to claim 1, wherein the movable contact member is attached to the movable component by a fourth welded joint produced by ultrasonic welding.

7. A temperature-dependent switch, comprising:
a first electrode;
a second electrode;
a temperature-dependent switching mechanism; and
a housing accommodating the switching mechanism;
wherein the first electrode is connected to a stationary contact that is arranged inside the housing, and wherein the switching mechanism comprises a component that is movable relative to the housing, on which movable component a movable contact member is arranged,
wherein the switching mechanism is configured to switch, depending on its temperature, between a closed state of the switch, in which the movable contact member interacts with the stationary contact and establishes an electrically conductive connection between the first electrode and the second electrode, and an open state of the switch, in which the movable contact member is kept at a distance from the stationary contact and the electrically conductive connection between the first electrode and the second electrode is disconnected, and
wherein (i) the stationary contact is attached to a part of the first electrode by a third welded joint produced by ultrasonic welding, said part of the first electrode being arranged inside the housing and/or (ii) the movable contact member is attached to the movable component by a fourth welded joint produced by ultrasonic welding.

8. The temperature-dependent switch according to claim 7, wherein the temperature-dependent switching mechanism comprises a bi-metal member, wherein the bi-metal member is the movable component on which the movable contact member is arranged.

9. The temperature-dependent switch according to claim 7, wherein the temperature-dependent switching mechanism comprises a bi-metal member and a spring member interacting with the bi-metal member, wherein the spring member is the movable component on which the movable contact member is arranged.

10. The temperature-dependent switch according to claim 9, wherein the bi-metal member comprises a temperature-dependent bi-metal snap disc, and wherein the spring member comprises a bistable spring snap disc.

11. The temperature-dependent switch according to claim 10, wherein the bi-metal member is held captive with clearance on the movable contact member.

12. The temperature-dependent switch according to claim 7, wherein the housing comprises an upper part and a lower part that is electrically insulated from the upper part, wherein the upper part forms the first electrode and the lower part forms the second electrode, and wherein the stationary contact is arranged on an inner side of the upper part facing an interior of the housing.

13. The temperature-dependent switch according to claim 7, wherein the housing comprises an upper part made of insulating material or PTC-material and a lower part, wherein the first electrode and the second electrode are arranged at the upper part.

14. The temperature-dependent switch according to claim 13, wherein the movable component is a contact element coupled to a bi-metal member, on which contact element a second movable contact member is arranged in addition to the movable contact member, and wherein a second stationary contact is attached to a part of the second electrode arranged inside the housing by a fifth welded joint produced by ultrasonic welding.

15. The temperature-dependent switch according to claim 7, wherein at least a part of the housing is made of insulating material or PTC-material, and wherein
(i) a first portion of the first electrode extends into an interior of the housing and a second portion of the first electrode extends outward from the interior of the housing
and/or
(ii) a first portion of the second electrode extends into the interior of the housing and a second portion of the second electrode extends outward from the interior of the housing.

16. A method of manufacturing a temperature-dependent switch, comprising the steps:
a) providing a switching mechanism and a housing comprising an upper part and a lower part, wherein at least a part of the upper part is made of electrically conductive material and forms a first electrode, and wherein at least a part of the lower part is made of electrically conductive material and forms a second electrode,
b) mounting the switching mechanism in the housing such that the first electrode is connected to a stationary contact that is arranged inside the housing and the switching mechanism comprises a component that is movable relative to the housing, on which movable component a movable contact member is arranged, and such that the switching mechanism is configured to switch, depending on its temperature, between a closed state of the switch, in which the movable contact member interacts with the stationary contact and establishes an electrically conductive connection between the first electrode and the second electrode, and an open state of the switch, in which the movable contact member is kept at a distance from the stationary contact and the electrically conductive connection between the first electrode and the second electrode is disconnected,
c) closing the housing by attaching the upper part to the lower part, wherein the upper part is electrically insulated from the lower part; and
d1) attaching a first terminal member to the first electrode by a first welded joint produced by ultrasonic welding, and/or
d2) attaching a second terminal member to the second electrode by a second welded joint produced by ultrasonic welding.

17. The method according to claim 16, wherein step d1) and/or step d2) is carried out after step c).

18. A method of manufacturing a temperature-dependent switch, comprising the steps:
a) providing a first electrode, a second electrode, a temperature-dependent switching mechanism, and a housing;
b) mounting the switching mechanism in the housing, such that the first electrode is connected to a stationary contact that is arranged inside the housing and the switching mechanism comprises a component that is movable relative to the housing, on which movable component a movable contact member is arranged, and such that the switching mechanism is configured to switch, depending on its temperature, between a closed state of the switch, in which the movable contact member interacts with the stationary contact and establishes an electrically conductive connection between the first electrode and the second electrode, and an open state of the switch, in which the movable contact member is kept at a distance from the stationary contact and the electrically conductive connection between the first electrode and the second electrode is open, and
c1) attaching the stationary contact to a part of the first electrode by a third welded joint produced by ultrasonic welding, said part of the first electrode being arranged inside the housing,
and/or
c2) attaching the movable contact member to the movable component by a fourth welded joint produced by ultrasonic welding.

19. The method according to claim 18, wherein step c1) and/or step c2) is carried out before the switching mechanism is mounted in the housing in step b).

20. The method according to claim 18, wherein a bi-metal member and a spring member interacting with the bi-metal member are provided as parts of the switching mechanism in step a), wherein the spring member forms the movable component on which the movable contact member is arranged, and wherein the movable contact member is attached to the spring member by the fourth welded joint produced by ultrasonic welding, and thereafter the bi-metal member is captively attached with clearance to the movable contact member before the switching mechanism is mounted in the housing in step b).
